(19) United States
(12) Patent Application Publication
(10) Pub. No.: US 2006/0081587 A1
(43) Pub. Date: Apr. 20, 2006

(54) Voltage stepdown structure of a drier

(76) Inventor: Hsin-Yun Lin, Taichung City (TW)

Correspondence Address: LEONG C LEI, PMB # 1008, 1867 YGNACIO VALLEY ROAD, WALNUT CREEK, CA, 94598, US

(21) Appl. No.: 10/943,967

(22) Filed: Sep. 20, 2004

(51) Int. Cl. H05B 1/00

(52) U.S. Cl. 219/240

(57) ABSTRACT

A voltage-stepdown structure of a drier is disclosed. The structure comprises a hollow body and a motor, a ceramic heat-emission component and a voltage stepdown component, enclosed within the hollow body, characterized in that one end of the heat-emission component is coated with a conductive thermal coat extended to the external of the hollow body and is disposed with a connection point for connecting to a wire, and the other end of the extension of the conductive thermal coat is provided with another connection point to connect a pole wire to the end of the diode of the motor, thereby the impedance of the extended length of the conductive thermal coat steps down the operation voltage, and the voltage stepdown component and the heat emission component of the drier are formed into a single structure, which allows not only in safety in current supply, but also simplified the overall structure of the drier.

### BACKGROUND OF THE INVENTION

(a) Technical Field of the Invention

The present invention relates to voltage stepdown structure, and in particular to a voltage stepdown structure which is an appropriate length of conductive thermal coat mounted on the ceramic heat emission body.

(b) Description of the Prior Art

FIG. 2 is a conventional drier having a hollow body 30 having one end being an outlet 31 and the other end being an inlet 31. The external side of the inlet 31 is a filter 32, and one side of the inlet 31 is disposed with a motor 33. The blades 34 of the motor 33 rotate to drive in air via the inlet 31. At the inner edge of the body of the drier, a resistance coil 35 is made to form as a voltage stepdown component, together with the heat emission body 36 and the switch seat at the handle 37, the power supply is controlled. The ceramic heat emission body 36 provides heat when a switch on the switch seat is in operation. The voltage step down coil 35 provides impedance so as to step down voltage. However, in practical, the coil 35 will generate heat and this will damage the ceramic heat emission body 36. Further, the voltage stepdown coil 35 not only has a complicated structure, but also lacks aesthetic appearance.

Accordingly, it is an object of the present invention to provide a voltage-stepdown structure of a drier, which mitigates the above drawbacks.

### SUMMARY OF THE INVENTION

Accordingly, it is an object of the present invention to provide a voltage-stepdown structure of a drier, wherein one end of the heat-emission component is coated with a conductive thermal coat extended to the external of the hollow body and is disposed with a connection point for connecting to a wire, and the other end of the extension of the conductive thermal coat is provided with another connection point to connect a pole wire to the end of the diode of the motor, thereby the impedance of the extended length of the conductive thermal coat steps down the operation voltage, and the voltage stepdown component and the heat emission component of the drier are formed into a single structure, which allows not only in safety in current supply, but also simplified the overall structure of the drier.

Yet another object of the present invention is to provide a voltage-stepdown structure of a drier, wherein the conductive coat on the heat emission body is made on the entire body to provide the requirements of the voltage stepdown operation, and the stripping off of the coat interrupts the electric conduction.

It is yet another object of the present invention to provide a voltage-stepdown structure of a drier, wherein the cost of production of the driver is greatly reduced.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the heat emission structure of a drier in accordance with the present invention.

FIG. 2 is a schematic view showing a conventional drier.

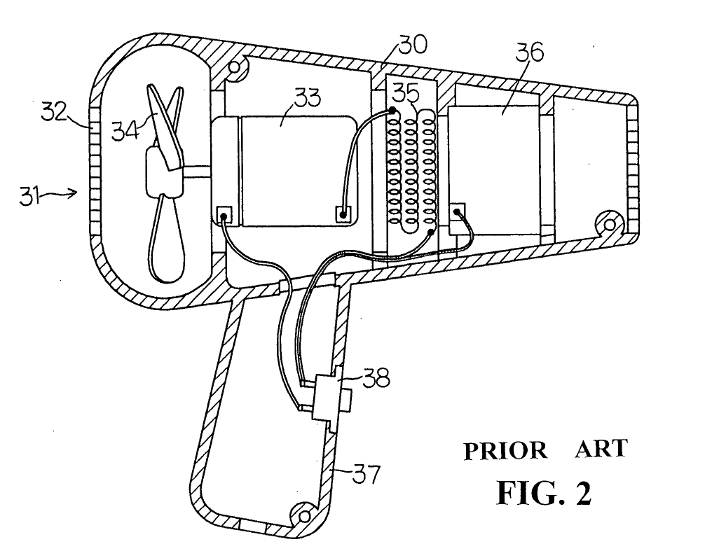

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

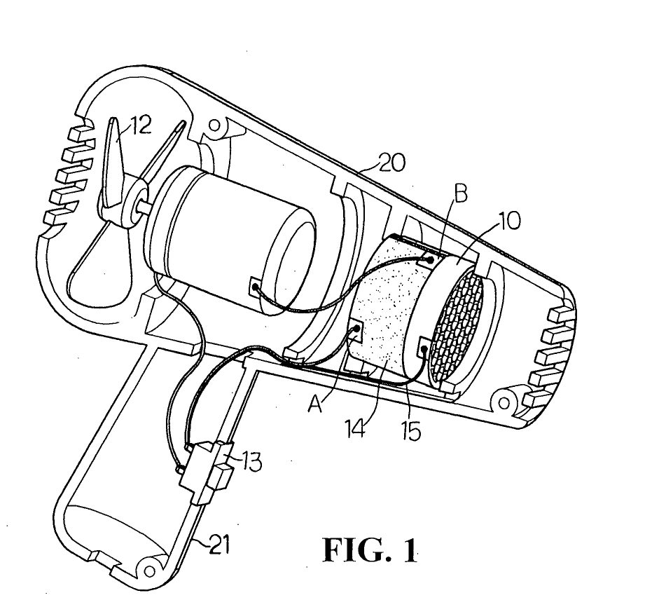

Referring to FIG. 1, there is shown a voltage-stepdown structure comprising a hollow body 20 which contains ceramic heat-emission component 10, a motor 11 with fan and blades 12. The appearance of the hollow body 20 can be made into various shapes depending on requirements. The heat emission body 10, the motor 11 and the blades 12 are positioned. The lateral side of the body 20 is extended to form a handle 21 so that the external wire passes to the switch seat 13, which controls the current to the components of the drier of the present invention.

In accordance with the present invention, the voltage-stepdown component required by the motor 11 is formed together with heat emission body 10 so that the structure of the drier is greatly simplified. Thus, the components of the drier are minimized, and the weight of the drier is reduced, which facilitates the usages of the drier. Most important, the current source to the motor 11 is stable and the operation of the motor 11 is accurately controlled.

In accordance with the present invention, the conductive thermal coat at one end of the heat emission body 10 is extended to form a section of conductive coat 14. On the conductive coat 14 a connection point A is formed for connection to a pole wire of the current supply such that the entire conductive thermal layer 14 is appropriately extended to a certain length. Based on the requirement of the voltage, the length of the coat 14 is restricted, and the end section of the coat 14 is provided with a connection point B for wiring 15 connected to the diode of the motor 11 for the voltage stepdown operation of the current supplied to the motor 11. The coat can be done on the external face of the heat emission body 10 and a predetermined length is reserved for stripping off at intervals, which provides intermittent operation of current supply. The intermittent operation of current supply will fulfill the operation requirements of voltage stepdown. The entire voltage stepdown is directly mounted on the face of the heat emission body 10.

The impedance of the conductive thermal coat together with the stable characteristics of the ceramic heat emission, the drier has a safe operation voltage. The heat emission body 10 and the voltage stepdown structure are combined, the size of the body 20 of the drier is greatly reduced. Thus the cost of manufacturing of the drier is reduced. The body 20 can be made from transparent material and only the heat emission body 10 is contained within the housing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A voltage-stepdown structure of a drier having a hollow body and a motor, a ceramic heat-emission component and a voltage stepdown component, enclosed within the hollow body, characterized in that one end of the heat-emission component is coated with a conductive thermal coat extended to the external of the hollow body and is disposed with a connection point for connecting to a wire, and the other end of the extension of the conductive thermal coat is provided with another connection point to connect a pole wire to the end of the diode of the motor, thereby the impedance of the extended length of the conductive thermal coat steps down the operation voltage, and the voltage stepdown component and the heat emission component of the drier are formed into a single structure, which allows not only in safety in current supply, but also simplified the overall structure of the drier.

2. The voltage stepdown structure of a drier of claim 1, wherein the conductive coat on the heat emission body is made on the entire body to provide the requirements of the voltage stepdown operation, and the stripping off of the coat interrupts the electric conduction.
